(19) United States
(12) Patent Application Publication
(10) Pub. No.: US 2023/0215274 A1
(43) Pub. Date: Jul. 6, 2023

(54) INTERSECTION RIGHT-TURN PEDESTRIAN ALERT SYSTEM

(71) Applicant: Gevin Joseph McDaniel, Tallahassee, FL (US)

(72) Inventor: Gevin Joseph McDaniel, Tallahassee, FL (US)

(21) Appl. No.: 18/146,603

(22) Filed: Dec. 27, 2022

Related U.S. Application Data
(60) Provisional application No. 63/266,251, filed on Dec. 30, 2021.

(51) Int. Cl. G08G 1/16

(52) U.S. Cl. CPC G08G 1/166

(57) ABSTRACT

A system for alerting right-turning vehicle drivers (and automated driving systems) of the presence of pedestrians in front of their vehicles.

This application claims the benefit of U.S. Provisional Patent Application 63/266,251, filed Dec. 30, 2021, the entire content of which is hereby incorporated by reference.

### TECHNICAL FIELD

This disclosure relates to a system to alert drivers of vehicles of the presence of pedestrians within a crosswalk while preparing to make a right-turn movement.

### BACKGROUND

One of the most common crash types between pedestrians and vehicular traffic is the pedestrian being struck by a right-turning vehicle.

### SUMMARY

An Intersection Right-Turn Pedestrian Alert System (IRTPAS) as described in this disclosure may be placed at an intersection to alert drivers of vehicles of the presence of a pedestrian within a crosswalk. At intersections, right-turning vehicle driver typically must look left toward oncoming traffic to determine when they have the opportunity to make the right-turn movement to merge into traffic. A typical reaction to the opportunity to make the right-turn movement is to keep looking left, while accelerating to make a successful merge into the traffic lane. During this time, pedestrians are allowed to enter the crosswalk and could be in front of a vehicle as the driver of the vehicle begins to accelerate. Typically, this results in serious injury or fatality for the pedestrian.

An IRTPAS may be installed at any intersection with permissible right-turning movements to notify the drivers of the presence of the pedestrian. In one example, the notification could be in the form of a flashing beacon in combination with a sign. This could be triggered when the right-turning vehicle is at the intersection and a pedestrian is about to enter the crosswalk or is present within the crosswalk. The presence of the pedestrian could be automatically detected by a pedestrian detection device. These IRTPAS devices could be incorporated to work in conjunction with other features at the intersection to reduce the potential for pedestrian injuries and fatalities.

It is contemplated that IPTPAS systems can be included in the vehicles by the vehicle manufacturers. In this use case, when the vehicle's right turn signal is activated or the steering wheel is turned toward the right while the vehicle is stopped, the vehicle's sonar/lidar equipment or other detection equipment could alert the driver of people on the right side and in front of the vehicle. Furthermore, the vehicle could be programmed to automatically stop or not allow acceleration until the area is clear.

The details of one or more examples are set forth in the accompanying drawings and the description below. Other features, objects, and advantages will be apparent from the description, drawings, and claims. It is apparent that if the IRTPAS system is used in a location where drivers use the opposite lane, such as the United Kingdom, it would be applicable to the left-turning movements and any devices could be placed opposite hand of the intersection. It is apparent that the IRTPAS system may be used to detect other users of the transportation system such as bicyclists, micro-mobility device users, and other non-motorized transportation users.

### BRIEF DESCRIPTION OF DRAWINGS

FIG. 1 illustrates a plan view of an intersection with a vehicular driver waiting for an opportunity to make a right-turn movement and focused on the upcoming gap in traffic.

FIG. 2 illustrates a plan view of an intersection with a motorist waiting for an opportunity to make a right-turn movement and focused on the upcoming gap in traffic as a pedestrian approaches the intersection from the right side of the motorist.

FIG. 3 illustrates a plan view of an intersection with a motorist accelerating to make a right-turn movement as a pedestrian is attempting to cross in front of the right-turning motorist resulting in the pedestrian being struck by the vehicle.

FIG. 4 illustrates a plan view of an intersection comprising an IRTPAS with a motorist waiting for an opportunity to make a right-turn movement and focused on the upcoming gap in traffic.

FIG. 5 illustrates a plan view of an intersection comprising an IRTPAS alerting a motorist of the presence of an approaching pedestrian while waiting for an opportunity to make a right-turn movement and focused on the upcoming gap in traffic as the pedestrian approaches the intersection from the right side of the motorist.

FIG. 6 illustrates a plan view of an intersection comprising an IRTPAS with a motorist noticing and yielding to the pedestrian within the crosswalk.

### DETAILED DESCRIPTION

The safety of road users such as pedestrians and bicyclists is one of the top priorities with transportation agencies all over the world. Sidewalks and shared use paths are used on the transportation system to provide for modes of transportation such as walking or riding bicycles, scooters, wheelchairs, or other types of micro-mobility devices.

Under current practice, there is no known device to warn right-turning motorists of the presence of a pedestrian within the crosswalk and to the right of the motorists while looking left for a gap in traffic. With the IRTPAS, the motorist will have a warning within their cone of vision to become aware of the presence of a pedestrian to their right.

The IRTPAS described herein may be implemented in many different ways depending on the type of non-motorized transportation path, configuration of the intersection, and configuration of other devices at the intersection such as light poles, traffic signals, or signs. One specific implementation is shown in the Figures, but it should be apparent that other implementations are also within the scope of this disclosure. The following is a detailed description of an example implementation for an IRTPAS.

The Figures illustrate one specific application of the IRTPAS showing how the system may be implemented to prevent a vehicle to pedestrian crash. Although the use for vehicle to pedestrian is specifically mentioned, as discussed further below, the use of the IRTPAS is not limited to applications for sidewalks and crosswalks for pedestrians. It is contemplated, however, the IRTPAS described in this disclosure may be used to provide alerts on other types of facilities such as bicycle and other non-motorized transportation facilities. It is also contemplated that the IRTPAS may be supplemented by additional traffic control devices and other types of intersections to alert users of the transportation system of unexpected conditions.

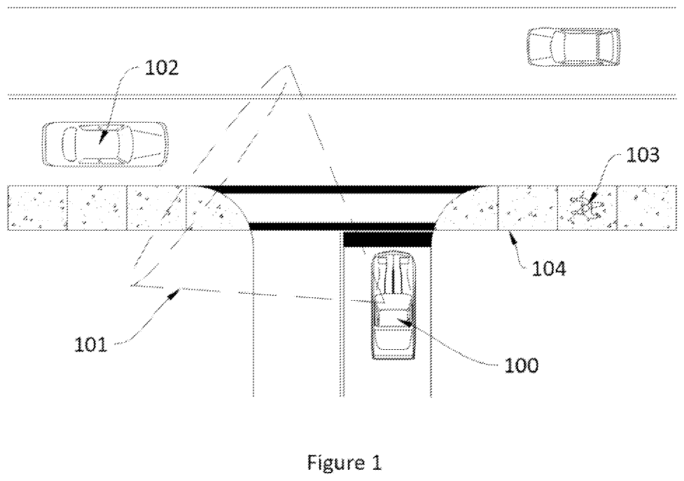

FIG. 1 illustrates a plan view of an intersection without an IRTPAS comprising a vehicular driver 100 waiting for an opportunity to make a right-turning movement. The driver's 100 cone of vision 101 is focused on an approaching vehicle 102. A pedestrian 103 is approaching the intersection along a sidewalk 104. The driver 100 is unaware of the presence of the approaching pedestrian 103 because the driver's 100 cone of vision 101 is focused on the approaching vehicle 102 and timing the right-turning movement once the approaching vehicle 102 clears the intersection.

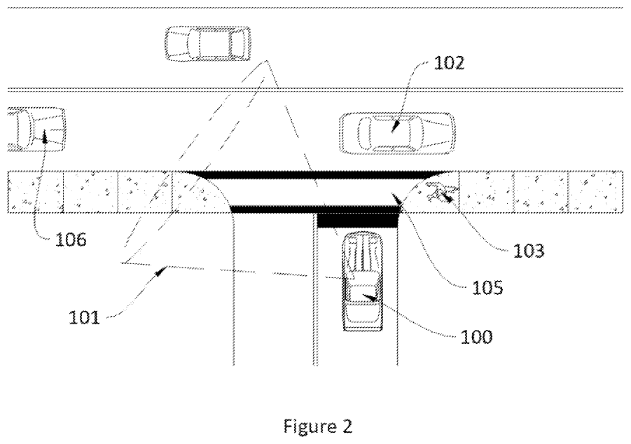

FIG. 2 illustrates a plan view of an intersection without an IRTPAS comprising a vehicular driver 100 waiting for an opportunity to make a right-turning movement and focused on the upcoming gap in traffic as a vehicle 102 begins to clear the intersection. A pedestrian 103 is at the intersection and about to enter the crosswalk 105. The driver 100 is unaware of the presence of the pedestrian 103 at the intersection because the driver's 100 cone of vision 101 is focused on additional approaching vehicles 106 and timing the right-turning movement once the vehicle 102 clears the intersection.

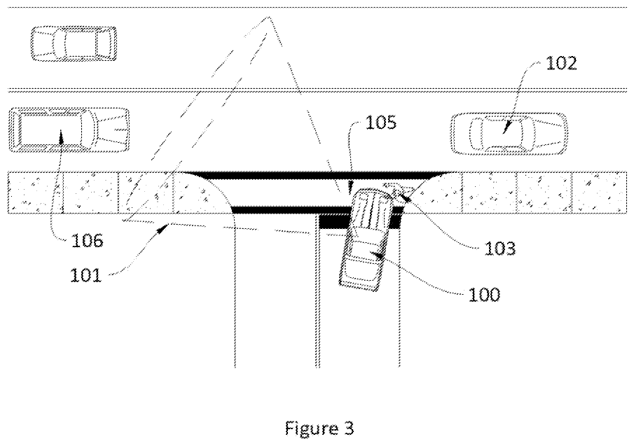

FIG. 3 illustrates a plan view of an intersection without an IRTPAS comprising a vehicular driver 100 accelerating to make a right-turn movement after vehicle 102 clears the intersection. The driver's 100 cone of vision 101 remains to the left toward additional oncoming vehicles 106 as the driver 100 accelerates into the traffic lane between vehicles 102 and 106. The right-turning driver 100 is unaware of a pedestrian 103 within the crosswalk 105 attempting to cross in front of the right-turning vehicle 100 resulting in the pedestrian 103 being struck by the vehicle.

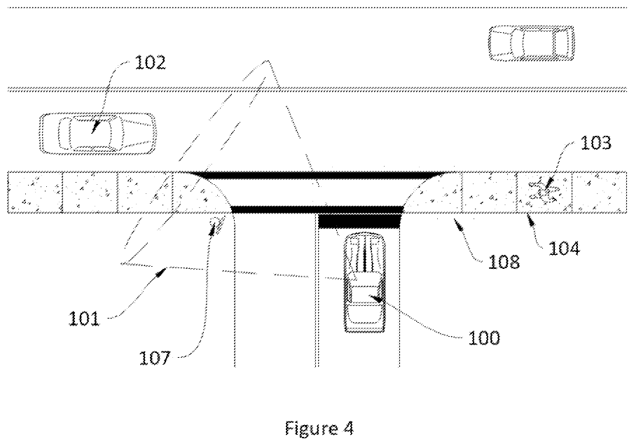

FIG. 4 illustrates a plan view of an intersection comprising an IRTPAS 107 with a vehicular driver 100 waiting for an opportunity to make a right-turning movement. The driver's 100 cone of vision 101 is focused on an approaching vehicle 102. A pedestrian 103 is approaching the intersection along a sidewalk 104. The driver 100 is unaware of the presence of the approaching pedestrian 103 because the driver's 100 cone of vision 101 is focused on the approaching vehicle 102 and timing the right-turning movement once the approaching vehicle 102 clears the intersection. The IRTPAS 107 has not yet alerted the driver of the presence of the pedestrian 103 because the pedestrian 103 has not yet entered the detection area 108 for the IRTPAS.

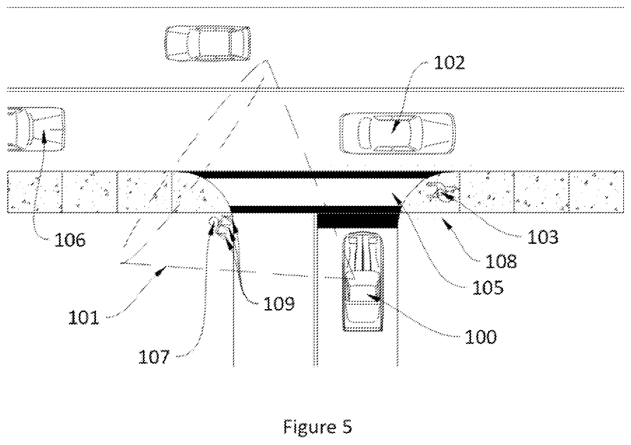

FIG. 5 illustrates a plan view of an intersection comprising an IRTPAS 107 with a vehicular driver 100 waiting for an opportunity to make a right-turning movement. The driver's 100 cone of vision 101 is focused on the upcoming gap in traffic as a vehicle 102 begins to clear the intersection. As pedestrian 103 approaches the intersection along a sidewalk 104, the pedestrian enters the detection area 108 for the IRTPAS. Immediately upon the pedestrian entering into the detection area, the 107 alerts the driver 100 of the presence of the pedestrian 103 by triggering pedestrian in front of vehicle warning sign with flashing beacons 109 located within the drivers 100 cone of vision 101.

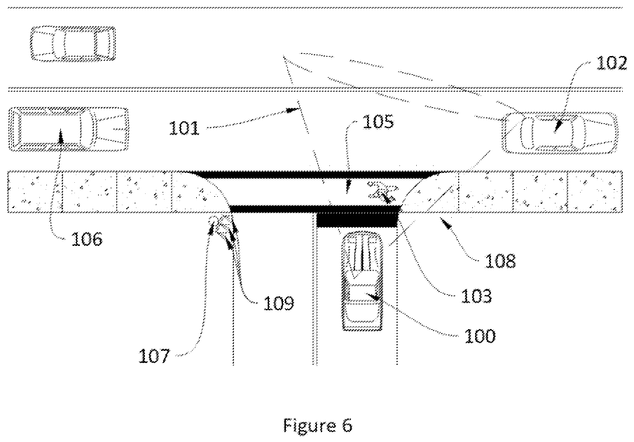

FIG. 6 illustrates a plan view of an intersection comprising an IRTPAS 107 with a vehicular driver 100 that has been alerted by the IRTPAS 107 comprising detection area 108 and pedestrian in front of vehicle warning sign with flashing beacons 109. The driver's 100 cone of vision 101 is now focused on the pedestrian 103 within the crosswalk 105. The driver 100 identifies the pedestrian 103 and yields to the pedestrian 103 within the crosswalk 105.

Various examples have been described. These and other examples are within the scope of the following claims.

What is claimed is:

1. A system for alerting right-turning vehicle drivers (or automated driving systems) of the presence of pedestrians near the front and right of their vehicles comprising:
pedestrian detection system;
pedestrian in front of vehicle alert.

2. The system of claim 1, wherein the detection system is a thermal detection system.

3. The system of claim 1, wherein the alert comprises a sign and flashing beacons on the left side of the driver's position.

4. The system of claim 1, wherein an audible and/or tactile alert is issued inside of the vehicle directly to the driver.

5. The system of claim 1, wherein the alert is automatically processed and addressed by automated vehicle technology.

6. The system of claim 1, wherein the system is used in the United Kingdom or another country where drivers use the opposing lane of travel, alerts a left-turning vehicle driver (or automated driving system) of the presence of pedestrians near the front and left of their vehicles.
